(19) United States
(12) Patent Application Publication
(10) Pub. No.: US 2017/0245002 A1
(43) Pub. Date: Aug. 24, 2017

(54) HDMI Matrix IP Transceiver

(71) Applicant: Paul Edward Harris, Manalapan, NJ (US)

(72) Inventor: Paul Edward Harris, Manalapan, NJ (US)

(21) Appl. No.: 15/048,571

(22) Filed: Feb. 19, 2016

(51) Int. Cl. H04N 21/4363; H04N 21/436; H04L 12/933

(52) U.S. Cl. CPC H04N 21/43635; H04L 49/109; H04N 21/43615

(57) ABSTRACT

An electronic device comprised of an HDMI Matrix/Switcher IC and IP Extension Processor. The invention will carry out this process by utilizing an HDMI matrix/switcher IC to control the flow of the HDMI signals to and from the IP processor. This allows one or more sources to be selected as the input to the IP processor or received content from the IP processor to be routed through the input of the HDMI matrix/switcher to an HDMI output of the HDMI matrix/switcher. This topology when configured as a transmitter can send the HDMI source over IP and can select which input is to be sent to the local HDMI output(s) of the unit. When configured as a receiver the IP content being received can be sent to the HDMI output(s) of the unit or same unit can select from one of the other HDMI input(s). The main intent of the invention would be to eliminate the need for 2 different products to achieve the end to end results and it allows for local switching and loop-out capabilities of the HDMI sources.

The invention relates to an HDMI electronic IP extension device consisting of a single unit configurable as a transmitter or a receiver unit through the use of an integrated HDMI matrix circuit.

The invention will carry out this process by utilizing an HDMI matrix/switcher IC to control the flow of the HDMI signals to and from the IP processor. This allows one or more sources to be selected as the input to the IP processor or received content from the IP processor to be routed through the input of the HDMI matrix/switcher to an HDMI output of the HDMI matrix/switcher. This topology when configured as a transmitter can send the HDMI source over IP and can select which input is to be sent to the local HDMI output(s) of the unit. When configured as a receiver the IP content being received can be sent to the HDMI output(s) of the unit or same unit can select from one of the other HDMI input(s).

The main intent of the invention would be to eliminate the need for 2 different products to achieve the end to end results and it allows for local switching and loop-out capabilities of the HDMI sources.

Definition List 1

| Term | Definition |
|---|---|
| HDMI | A compact audio/video interface for |
| | transmitting uncompressed digital data. |
| | HDMI connects digital audio/video |
| | sources (such as set-top boxes, DVD |
| | players, HD DVD players, Blu-ray Disc |
| | players, AVCHD camcorders, personal |
| | computers (PCs), video game consoles |
| | such as the PlayStation 3 and Xbox 360, |
| | and AV receivers) to compatible digital |
| | audio devices, computer monitors, video |
| | projectors, tablet computers, and digital |
| | televisions. |
| DVI | a video interface standard covering the |
| | transmission of video between a source |
| | device (such as a personal computer) |
| | and a display device. |
| Display Port | a digital display interface standard |
| | produced by the Video Electronics |
| | Standards Association (VESA). It defines |
| | a royalty-free, digital audio/video |
| | interconnect, intended to be used |
| | primarily between a computer and its |
| | display, or a computer and a home- |
| | theater system. |
| SDI | a standard for digital video transmission |
| | over coaxial cable. |
| Ethernet | a family of computer networking |
| | technologies for local area networks |
| | (LANs) commercially introduced in 1980. |
| | Standardized in IEEE 802.3, Ethernet has |
| | largely replaced competing wired LAN |
| | technologies. |
| Category Cable (CAT) | A twisted pair cable for carrying signals. |
| | This type of cable is used in structured |
| | cabling for computer networks such as |
| | Ethernet. It is also used to carry other |
| | signals such as telephony and video. The |
| | cable is commonly connected using |
| | punch down blocks and modular |
| | connectors. Most Category cables are |
| | unshielded, relying on the twisted pair |
| | design and differential signaling for |
| | noise rejection. There are different |
| | grades of cable available and code as 5, |
| | 5e, 6, or 7 accordingly. |
| Matrix | The ability to route a video or pc source |
| | to one or more destinations. |
| IP Extension | Method of delivering video content via |
| | Ethernet by fiber or CAT cable with or |
| | without compression. |

### DESCRIPTION OF DRAWINGS

FIG. 1 is a block diagram outlining the basic connection of the HDMI inputs and outputs to a single IP Processor with 2 HDMI connector inputs and 1 HDMI connector Output.

FIG. 2 is a block diagram outlining the basic connection of the HDMI inputs and outputs to two IP Processors with 2 HDMI connector inputs and 1 HDMI connector Output.

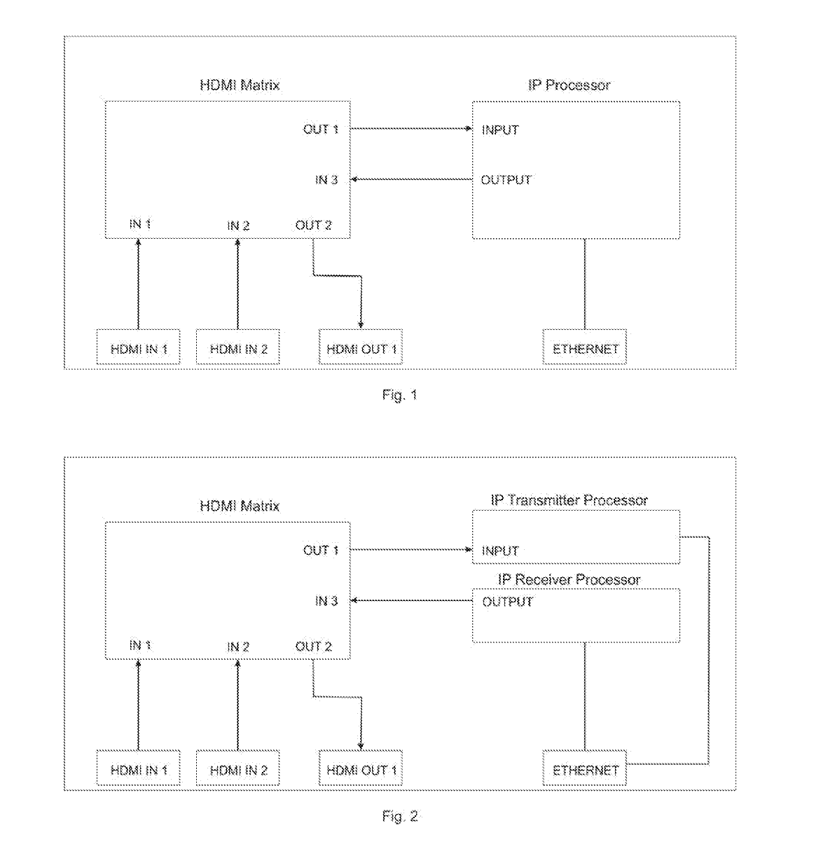

What is claimed is:

1. An electronic device comprising:
of a single unit configurable as a transmitter or a receiver IP extension unit through the use of an integrated HDMI matrix circuit; whereby the HDMI matrix/switcher IC controls the flow of the HDMI signals to and from the IP processor and allows one or more sources to be selected as the input to the IP processor or received content from the IP processor to be routed through the input of the HDMI matrix/switcher to one or more HDMI outputs of the HDMI matrix/switcher.

2. The transceiver unit capabilities of claim 1 using Display Port instead of HDMI.

3. The transceiver unit capabilities of claim 1 using DVI instead of HDMI.

4. The transceiver unit capabilities of claim 1 using SDI instead of HDMI.
